(19) United States
(12) Patent Application Publication
(10) Pub. No.: US 2015/0013131 A1
(43) Pub. Date: Jan. 15, 2015

(54) Sprinkler Head Accessory Mounting Tool

(71) Applicant: SENJU SPRINKLER CO., LTD., Tokyo (JP)

(72) Inventor: Yasuaki Koiwa, Tokyo (JP)

(73) Assignee: SENJU SPRINKLER CO., LTD., Tokyo (JP)

(21) Appl. No.: 14/377,010

(22) PCT Filed: Feb. 5, 2013
(86) PCT No.: PCT/JP2013/052528

§ 371 Date: Aug. 6, 2014

(30) Foreign Application Priority Data
Feb. 22, 2012 (JP) 2012-035871
May 21, 2012 (JP) 2012-115327

(51) Int. Cl. B25B 27/02; A62C 35/68

(52) U.S. Cl. CPC B25B 27/02; A62C 35/68
USPC 29/278

(57) ABSTRACT

A sprinkler head accessory mounting tool that allows an operator who mounts a sprinkler head accessory on a sprinkler head to reduce a burden such as purchasing and carrying a mounting tool for each shape or size of sprinkler head accessory is provided. In a mounting tool for mounting a sprinkler head accessory on a sprinkler head to cover a hole formed at an installation position of the sprinkler head on a ceiling, a main body includes a plurality of support sections on which the sprinkler head accessory can be put, and a grip rod attachment and detachment section is disposed on an opposite side of support sections. Alternatively, a support section holding member on which the sprinkler head accessory can be put is configured to be detachable from a grip rod attachment and detachment section holding member.

### TECHNICAL FIELD

The present invention relates to mounting tools for mounting a sprinkler head accessory such as a sprinkler head cover and a ceiling plate on a sprinkler head.

### BACKGROUND ART

Sprinkler heads are installed in ceilings or walls in buildings and have nozzles at one end which are connectable to a piping which is in connection with a water supply and a heat sensitive operating element at the other end. At normal times, the heat sensitive operating element supports a valve element which closes the nozzles.

Examples of the above sprinkler heads include concealed type sprinkler heads that are flush mounted in ceilings or walls and are covered with a sprinkler head cover.

The concealed type sprinkler head shown in FIG. 8 includes a sprinkler head 50 and a sprinkler head cover (sprinkler head accessory) 51 which is to be mounted on the sprinkler head. The sprinkler head 50 is installed on the backside of the ceiling and is covered with the sprinkler head cover 51 at normal times such that only a cover plate 52 is visible inside the room.

The above sprinkler head cover 51 is mounted on the sprinkler head 50 in the following manner.

The sprinkler head 50 is connected to a piping A on the backside of the ceiling and only the distal end of the sprinkler head 50 is exposed through a hole 54 that is formed on a ceiling board 53. The sprinkler head cover 51 is mounted on the sprinkler head 50. A cylindrical portion 55 of the sprinkler head cover 51 is inserted into a cylindrical support cup 56 that is disposed outside the sprinkler head 50. A spiral groove 57 is formed on the side face of the support cup 56, and claws 58 that are capable of engaging with the spiral groove 57 are disposed on the cylindrical portion 55 of the sprinkler head cover 51. The claws 58 are elastically deformable. As the cylindrical portion 55 is moved toward the piping A, the claws 58 are elastically deformed to move across the spiral groove 57 so as to allow the cylindrical portion 55 to be moved to the piping A.

When the sprinkler head cover 51 is pushed upward until a flange 59 which is disposed at the lower end of the cylindrical portion 55 reaches the underside of the ceiling board 53, the claws 58 engage with the spiral groove 57 and the mounting operation is completed.

In the mounting operation of the sprinkler head cover, a mounting tool for the sprinkler head cover is used (for example, see Japanese Unexamined Patent Application Publication No. 2011-120699). Since the sprinkler head cover is used, dirt on work gloves can be prevented from being attached on the surface of the sprinkler head cover. Further, since an operator uses the mounting tool and does not directly hold the sprinkler head cover, the cover plate can be prevented from being deformed.

### CITATION LIST

### Patent Literature

PTL 1: Japanese Unexamined Patent Application Publication No. 2011-120699

### SUMMARY OF INVENTION

### Technical Problem

Recently, there are a variety of shapes for the sprinkler head covers. Although sprinkler head covers having a circular outer shape have been mainly used, there is a need for sprinkler head covers having a rectangular outer shape. In addition, for the sprinkler head covers having a circular outer shape, there is a need for a variety of sizes of outer diameter of the sprinkler head covers.

However, since it is a burden for the operator to purchase or carry a mounting tool for each shape or size of the sprinkler head cover, a mounting operation of the sprinkler head cover may be performed without using a mounting tool, which leads to contamination or deformation of the cover plate. As a result, the aesthetic appearance of the ceiling may be degraded.

In view of the above problem, the present invention aims to provide a sprinkler head accessory mounting tool that allows the operator who mounts the sprinkler head accessory on the sprinkler head to reduce the burden such as purchasing and carrying a mounting tool for each shape or size of sprinkler head accessory.

### Solution to Problem

In order to achieve the above object, the present invention provides the following sprinkler head accessory mounting tool.

That is, a sprinkler head accessory mounting tool for mounting a sprinkler head accessory on a sprinkler head to cover a hole formed at an installation position of the sprinkler head on a ceiling or wall surface includes a main body and a grip rod, the main body including a plurality of support sections on which the sprinkler head accessory can be put and a grip rod attachment and detachment section.

According to the sprinkler head accessory mounting tool of the present invention (hereinafter, the term “mounting tool” refers to the “sprinkler head accessory mounting tool” unless otherwise specified), since a plurality of support sections are disposed on the main body, each of the sprinkler head accessories having different shapes and sizes (hereinafter, the term “accessory” refers to the “sprinkler head accessory” unless otherwise specified) can be put on each of the support sections. Accordingly, a single mounting tool can be used for a plurality of types of accessories, thereby reducing the burden of the operator such as purchasing and carrying a mounting tool for each shape or size of the accessory.

### Advantageous Effects of Invention

According to the sprinkler head accessory mounting tool of the present invention, a single mounting tool can be used for a plurality of types of accessories, thereby reducing the burden of the operator such as purchasing and carrying a mounting tool for each shape or size of the accessory. Further, contamination or deformation of the cover plate can be prevented by using the sprinkler head accessory mounting tool of the present invention.

### BRIEF DESCRIPTION OF DRAWINGS

FIG. 1 is a sectional view of a mounting tool and a sprinkler head cover according to a first embodiment.

FIG. 2 is a plan view of the mounting tool of FIG. 1.

FIG. 3 is a sectional view which shows that the sprinkler head cover has been mounted on the sprinkler head by the mounting tool of FIG. 1.

FIG. 4 is a sectional view of a mounting tool according to a modification 1 of the first embodiment in which three magnets are provided.

FIG. 5 is a plan view of the mounting tool of FIG. 4.

FIG. 6 is a plan view of a mounting tool according to a modification 2 of the first embodiment in which another magnet is provided.

FIG. 7 is a plan view of the mounting tool of FIG. 6.

FIG. 8 is a sectional view of a sprinkler head cover and a sprinkler head of the conventional art.

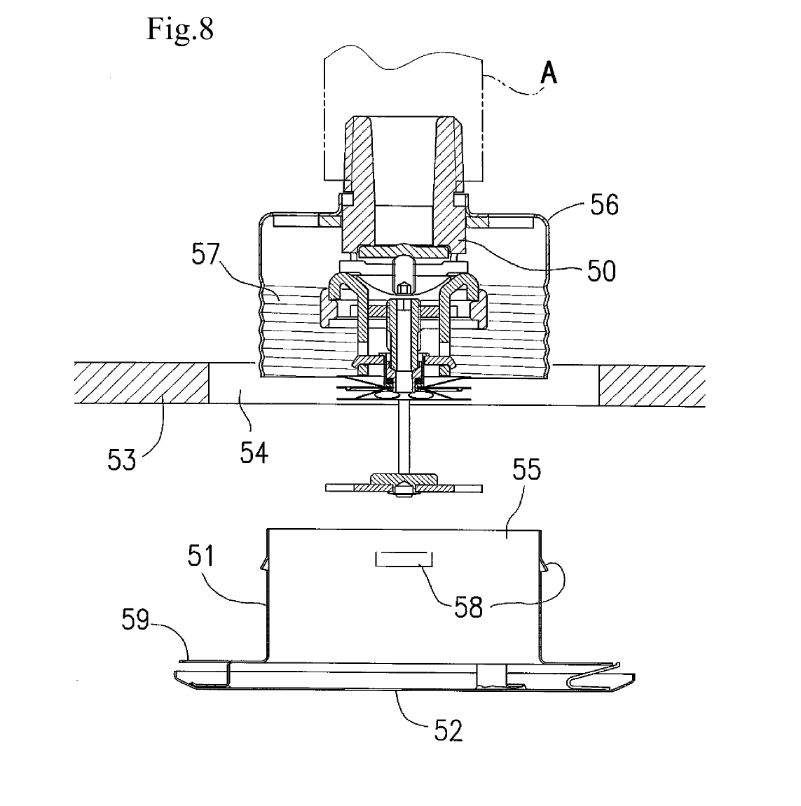

FIG. 9 is a sectional view of a modification 3 of the first embodiment.

FIG. 10 is a sectional view of a modification 4 of the first embodiment.

FIG. 11(a) is a plan view of a modification 5 of the first embodiment, FIG. 11(b) is a sectional view of a support section of FIG. 11(a), and FIG. 11(c) is an enlarged sectional view of a portion surrounded by the dotted line of FIG. 11(b).

FIG. 12(a) is a plan view of a modification 6 of the first embodiment, FIG. 12(b) is a view which shows that a circular cover plate is mounted on FIG. 12(a), and FIG. 12(c) is a view which shows that a rectangular cover plate is mounted on FIG. 12(a).

FIG. 13 is a sectional view of the mounting tool of a second embodiment.

### DESCRIPTION OF EMBODIMENTS

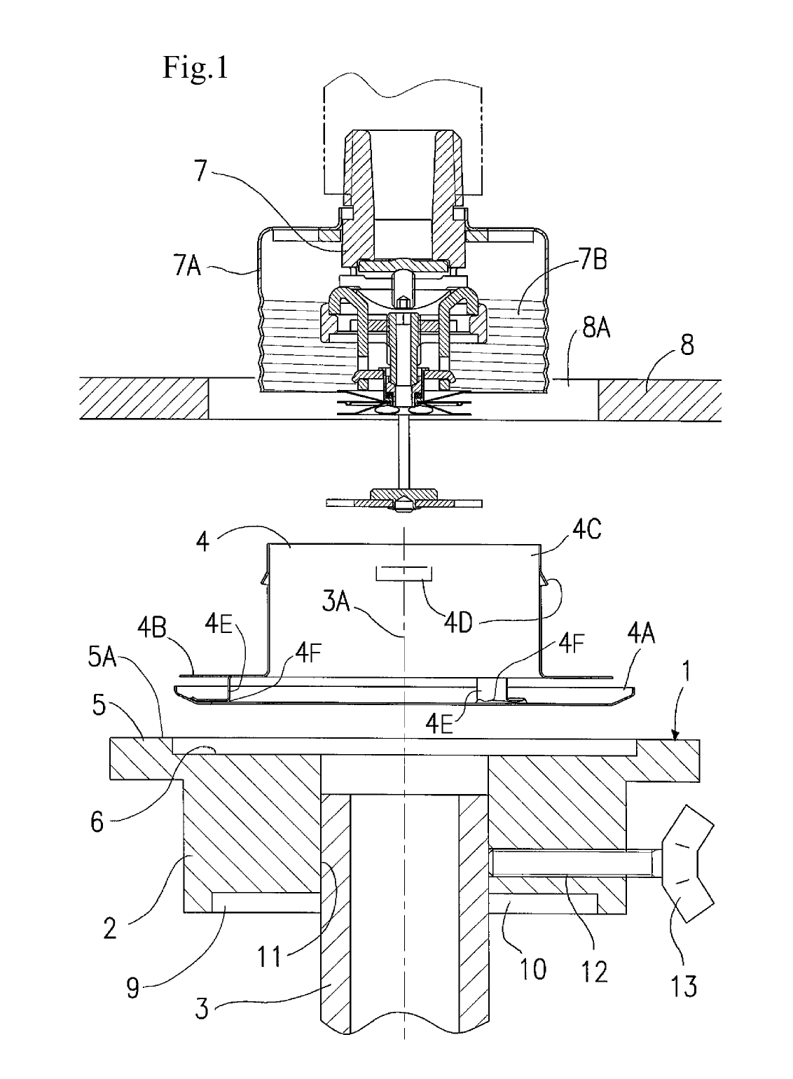

### First Embodiment (FIGS. 1 to 3)

A sprinkler head accessory mounting tool (hereinafter, referred to as “mounting tool”) 1 according to a first embodiment includes a main body 2 and a grip rod 3, which are made of a lightweight material such as resin and aluminum alloy. The main body 2 is formed in a cylindrical shape and has a support section 5 that is capable of supporting a sprinkler head cover 4 which is a sprinkler head accessory.

A cover plate 4A which is disposed at a lower end of the sprinkler head cover 4 is put on the support section 5, and a recess 6 corresponding to the outer shape of the cover plate 4A is disposed on the support section 5. The depth of the recess 6 is designed such that a ceiling abutment portion 4B is located above the end face of the recess 6 when the sprinkler head cover 4 is housed in the recess 6, and more preferably, the depth of the recess 6 is smaller than the height of the cover plate 4A. Accordingly, when the cover plate 4A is put in the recess 6 so as to connect the sprinkler head cover 4 to the sprinkler head 7 which is installed on the backside of the ceiling, the ceiling abutment portion 4B of the sprinkler head cover 4 can abut against the surface of a ceiling board 8 before a top surface 5A of the support section 5 interferes with the surface of the ceiling board 8. Further, since the cover plate 4A is housed in the recess 6, the sprinkler head cover 4 can be prevented from being moved or being unstable on the support section 5.

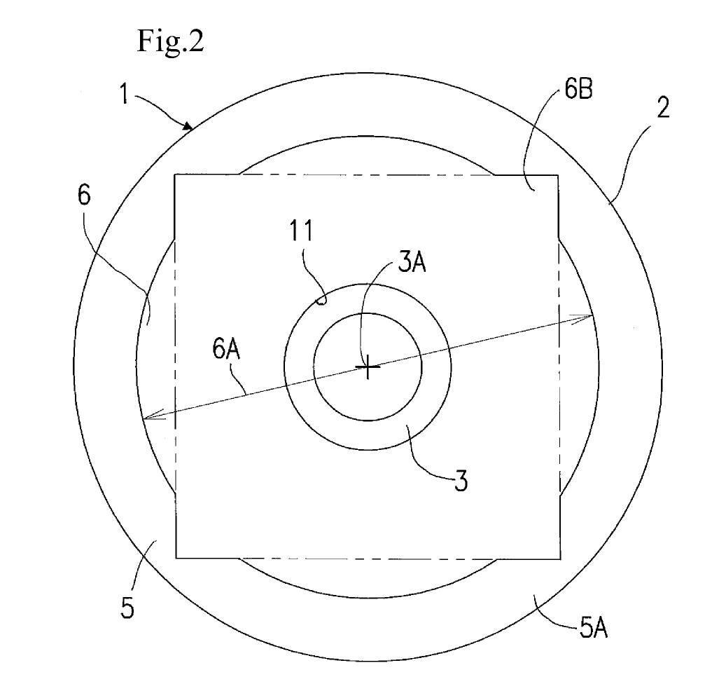

As shown in FIG. 2, a contour shape of the recess 6 is the shape of overlapped circle and rectangle with the four corners of the rectangle extending outward from the edge of the circle. Accordingly, the recess 6 can accommodate two types of the sprinkler head cover having the cover plate 4A of circular outer shape and rectangular outer shape.

A support section 9 having a recess formed in a shape different from the shape of the recess 6 is disposed on the opposite side of the support section 5. In this embodiment, a recess 10 disposed on the support section 9 is in a circular shape and has a diameter smaller than a diameter dimension 6A of the recess 6.

That is, the recess 6 on the support section 5 which is the first support section accommodates two types of the sprinkler head covers having the cover plate 4A of circular outer shape and rectangular outer shape, while the recess 10 on the support section 9 which is the second support section accommodates the sprinkler head covers having a diameter smaller than that of the recess 6. Accordingly, a mounting tool 1 which accommodates three types of the sprinkler head covers can be achieved. In other words, a plurality of accessories can be accommodated by one side of the mounting tool 1. Accordingly, an operator who mounts the sprinkler head cover 4 on the sprinkler head 7 can reduce the burden such as purchasing or carrying a mounting tool for each type of cover plate.

The grip rod 3 has a hollow shape and is disposed on the main body 2 on the opposite side of the support section 5. A grip rod attachment and detachment section 11 is formed on the main body 2 on the opposite side of the support section 5 and has a hole so that the grip rod 3 can be inserted therethrough. The grip rod attachment and detachment section 11 has a hole diameter which is slightly larger than the outer peripheral diameter of the grip rod.

The hole of the grip rod attachment and detachment section 11 penetrates the main body 2 and reaches the support sections 5 and 9. When the support section 5 is used to receive the sprinkler head cover 4, the grip rod 3 is inserted from the support section 9 to be secured to the main body 2, and when the support section 9 is used, the grip rod 3 is inserted from the support section 5 so as to be secured to the main body 2. Accordingly, two support sections 5 and 9 disposed on a single main body 2 can be used.

In a configuration to secure the grip rod 3 to the main body 2, a hole is formed to penetrate from the side face of the main body 2 to the grip rod attachment and detachment section 11 with an internal thread 12 threaded on the inner surface of the hole. The grip rod 3 can be detachably secured to the main body 2 by screwing a bolt 13 into the internal thread 12 so that the distal end of the bolt 13 is pressed against the side face of the grip rod 3. When the internal thread 12 is not threaded on the inner surface of the hole which penetrates from the side face of the main body 2 to the grip rod attachment and detachment section 11, a tapping screw can be used as the bolt 13. The grip rod 3 can be detachably secured to the main body 2 by screwing the distal end of the tapping screw into the side face of the grip rod 3.

In the above configuration, the center of the recesses 6, 10 are aligned with a center axis 3A of the grip rod 3. Accordingly, the center axis of the sprinkler head cover 4 is positioned on the center axis of the grip rod 3, which allows for general recognition of the center position of the sprinkler head cover 4 during the mounting operation of the sprinkler head cover 4 on the sprinkler head 7. Further, the center axis 3A in FIG. 2 (the intersection of “+”) is the center axis of the main body 2 which is a circular cylindrical shape.

Next, an operation in which the sprinkler head cover 4 is mounted on the sprinkler head 7 using a mounting tool of the first embodiment will be described.

The following explains the case where the sprinkler head cover 4 is put on the support section 5. First, the grip rod 3 is secured to the main body 2. The grip rod 3 is inserted into the grip rod attachment and detachment section 11 of the main body 2 from the support section 9, and the bolt 13 is screwed into the internal thread 12. The grip rod 3 is secured to the main body 2 by tightening the bolt 13. The main body 2 and the grip rod 3 are preferably made of a lightweight material so as to reduce the burden of the operator. Specifically, the material may be resin or aluminum, and the grip rod 3 may be a commercially available resin pipe.

When the operator standing on the floor performs a mounting operation, the grip rod 3 preferably has a length of 1 to 2 meters. Alternatively, when the operator performs a mounting operation on a scaffold such as a stepladder, the grip rod 3 may have a smaller length in the order of 0.3 to 1 meter, or in some cases, the operator can use the mounting tool 1 by directly holding the main body 2 with his/her hand without using the grip rod 3.

Then, the cover plate 4A of the sprinkler head cover 4 is housed in the recess 6 of the support section 5. The operator brings the mounting tool 1 toward the sprinkler head 7 which is installed on the backside of the ceiling by holding the grip rod 3. A cylindrical portion 4C which is connectable to the sprinkler head 7 is disposed on the sprinkler head cover 4 on the opposite side of the cover plate 4A. The cylindrical portion 4C is inserted into a hole 8A formed on the ceiling board 8 and is connected to the sprinkler head 7 which is positioned at the back of the hole 8A.

Since the center axis of the grip rod 3 is aligned with the center position of the support section 5 in the mounting tool 1, the center axis of the head cover 4 is positioned on the center axis of the grip rod 3 in the state in which the head cover 4 is put on the mounting tool 1. Accordingly, the operator can generally recognize the center position of the head cover during the mounting operation of the head cover 4 on the sprinkler head 7.

Claws 4D that are engageable with a support cup 7A of the sprinkler head 7 are disposed on the cylindrical portion 4C. The claws 4D extend obliquely downward and have elasticity that allows the claws 4D to move across the uneven surface of grooves 7B formed on the support cup 7A when the cylindrical portion 4C is inserted into the support cup 7A.

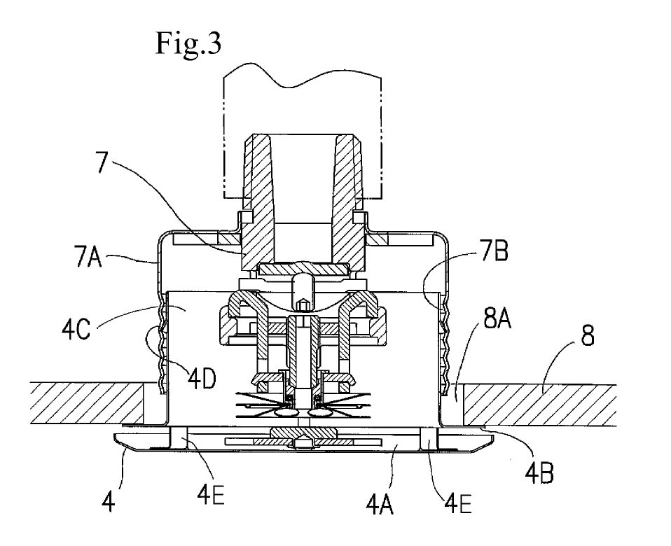

The sprinkler head cover 4 is moved to the sprinkler head 7 until the ceiling abutment portion 4B which is formed in a flange shape between the cylindrical portion 4C and the cover plate 4A abuts against the surface of the ceiling board 8. When the ceiling abutment portion 4B reaches the surface of the ceiling board 8, the mounting tool 1 is then moved downward. As the claws 4D on the cylindrical portion 4C engage the grooves 7B on the support cup 7A, the sprinkler head cover 4 is locked to the sprinkler head 7. Thus, the operation to mount the sprinkler head cover 4 on the sprinkler head 7 is completed (see FIG. 3).

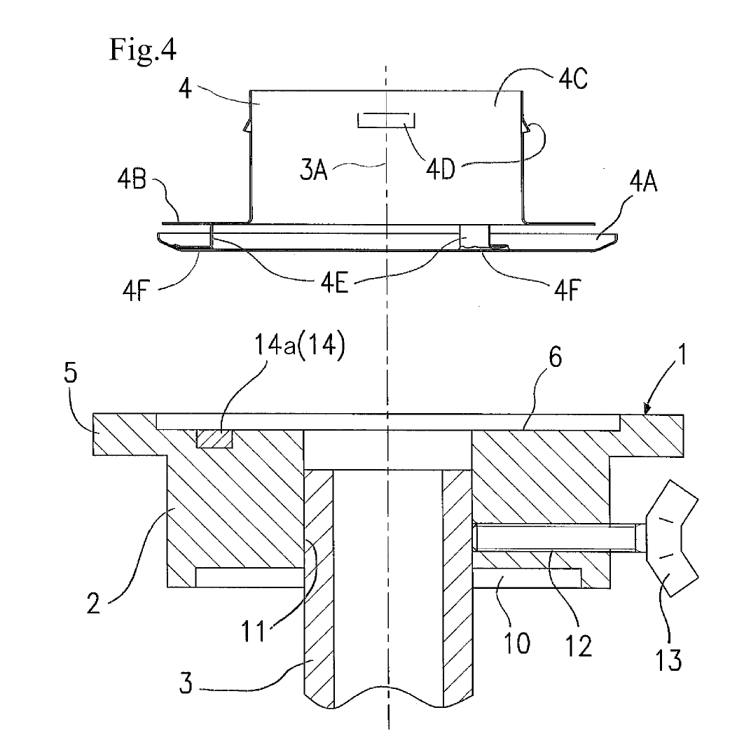

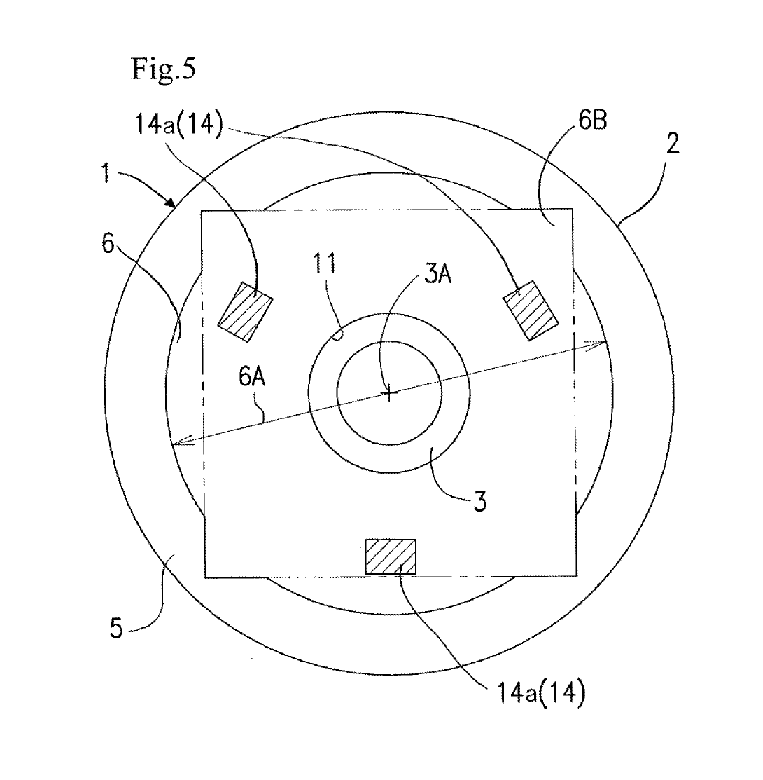

### Modification 1 of First Embodiment (FIGS. 4, 5)

The head cover 4 includes legs 4E which extend downward from the ceiling abutment portion 4B. The lower end portion of the leg 4E is bent to be parallel to the ceiling abutment portion and is adhered to the cover plate 4A with a low-melting alloy 4F interposed therebetween. The legs 4E are made of iron, and the adhesion surface of the low-melting alloy 4F of the legs 4E and magnets 14 are attracted to each other by a magnetic force.

In the modification shown in FIGS. 4, 5, the magnets 14 are disposed on the support section 5 at positions which correspond to the legs 4E. Since the magnets 14 are embedded in the mounting tool 1, the legs 4E of the head cover 4 and the magnets 14 are attracted to each other. Accordingly, the head cover 4 put on the mounting tool 1 is attracted to the mounting tool 1 due to a magnetic force during the mounding operation of the head cover 4, thereby preventing the head cover 4 from being easily fallen off from the head cover mounting tool 1. In this example, magnets 14a are positioned at three positions which correspond to the legs 4E with the surface of the magnets 14a being exposed to the surface of the recess 6.

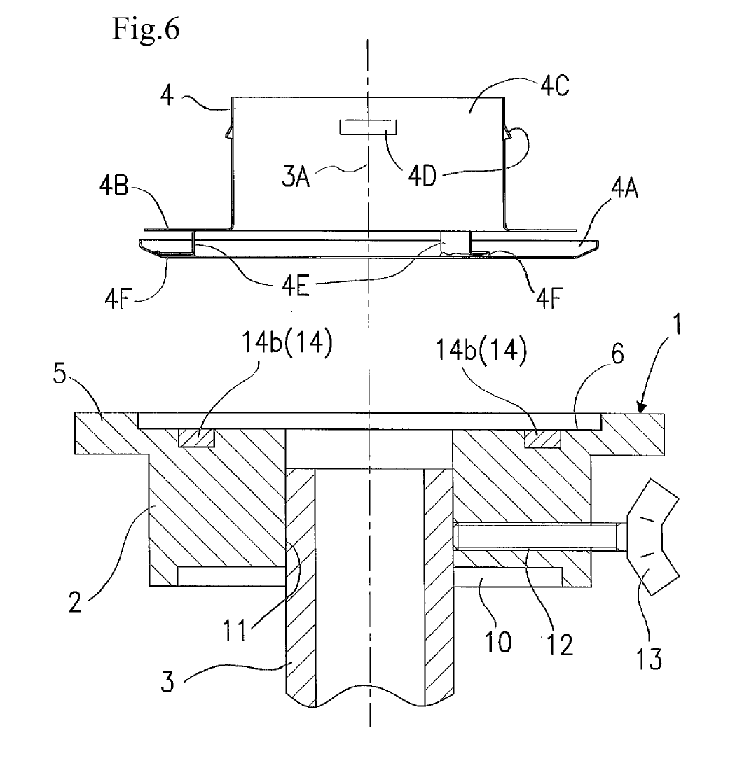

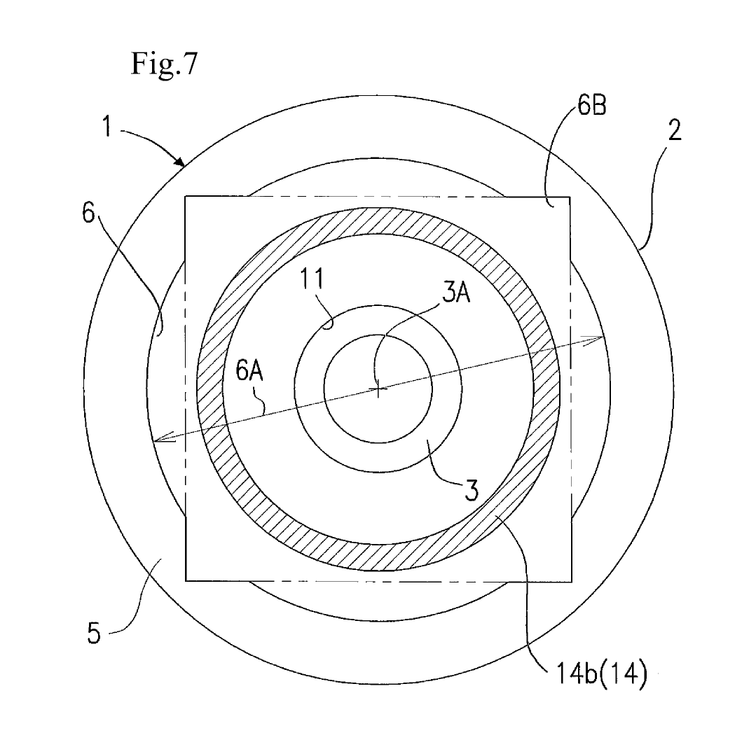

### Modification 2 of First Embodiment (FIGS. 6, 7)

The modification shown in FIGS. 6, 7 also includes the magnet 14. In this example, since an annular shaped magnet (annular magnet) 14b is used, the magnet 14 is positioned such that the three positions which correspond to the legs 4E are located on the annular shape. Accordingly, the annular shaped surface of the magnet 14 is exposed to the surface of the recess 6. Although the magnets 14a in the above mentioned modification need to be brought to the positions which correspond to the legs 4E, the annular shaped magnet 14 in this modification allows the legs 4E to be brought to any position on the annular shape, which is advantageous in that the mounting tool 1 and the head cover 4 can be easily magnetically connected.

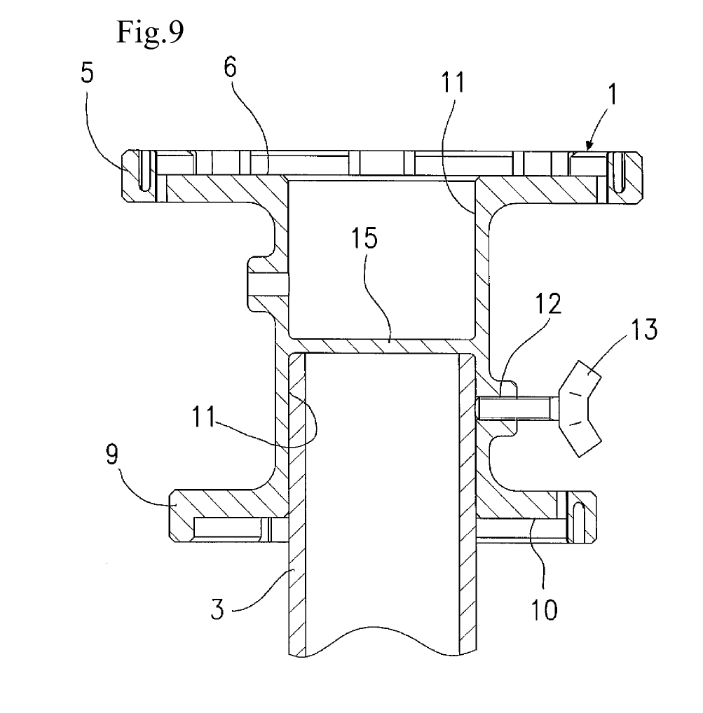

### Modification 3 of First Embodiment (FIG. 9)

In the modification of the first embodiment shown in FIG. 9, a stopper is provided in the grip rod attachment and detachment section 11 so that the end face of the grip rod 3 abuts against the stopper. A partition wall 15 disposed in the grip rod attachment and detachment section 11 serves as the stopper. In place of the partition wall 15, a step section may be formed in the grip rod attachment and detachment section 11 so that the grip rod 3 abuts against the step section, or alternatively, a projection may be formed in the grip rod attachment and detachment section 11. This prevents the grip rod 3 to extend through the support section 5 during the mounting operation of the sprinkler head cover 4 on the sprinkler head 7 by using the mounting tool 1.

As described in the above modification, since the stopper 15 is disposed in the grip rod attachment and detachment section 11 and is configured to anchor the grip rod 3, the distal end of the grip rod 3 which is inserted into the grip rod attachment and detachment section 11 from the second support section 9 can be prevented from protruding through the first support section 5 when the accessory 4 is put on the first support section 5. Accordingly, the grip rod 3 can be prevented from protruding and damaging the accessory 4 which is put on the first support section 5.

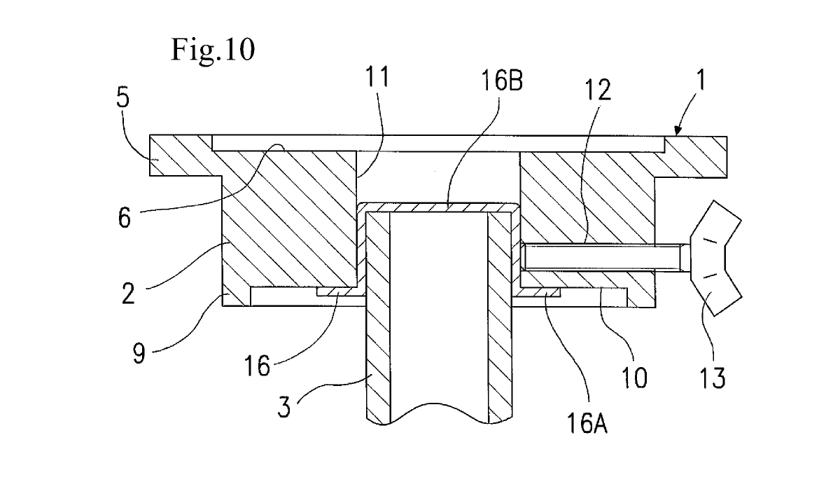

### Modification 4 of First Embodiment (FIG. 10)

Further, the modification shown in FIG. 10 includes a pipe cap 16 in place of the above partition wall 15. The pipe cap 16 is in a cylindrical shape and has a flange 16A that is engageable with the support section 9 at a lower end and a surface 16B that closes an upper end. The grip rod 3 is inserted into the pipe cap 16 and the pipe cap 16 is inserted into the grip rod attachment and detachment section 11. Then, the pipe cap 16 is fixed by pressing the distal end of the bolt 13 against the side face of the pipe cap 16.

Accordingly, the mounting tool 1 can be configured to be lightweight and compact compared to the modification of FIG. 9, thereby reducing the burden of the operator.

Further, unlike the foregoing modification, the stopper can be formed by the pipe cap without providing a stopper in the grip rod attachment and detachment section 11. Accordingly, prevention of protrusion of the grip rod 3 can be easily achieved without difficulty of forming a stopper in the mounting tool 1.

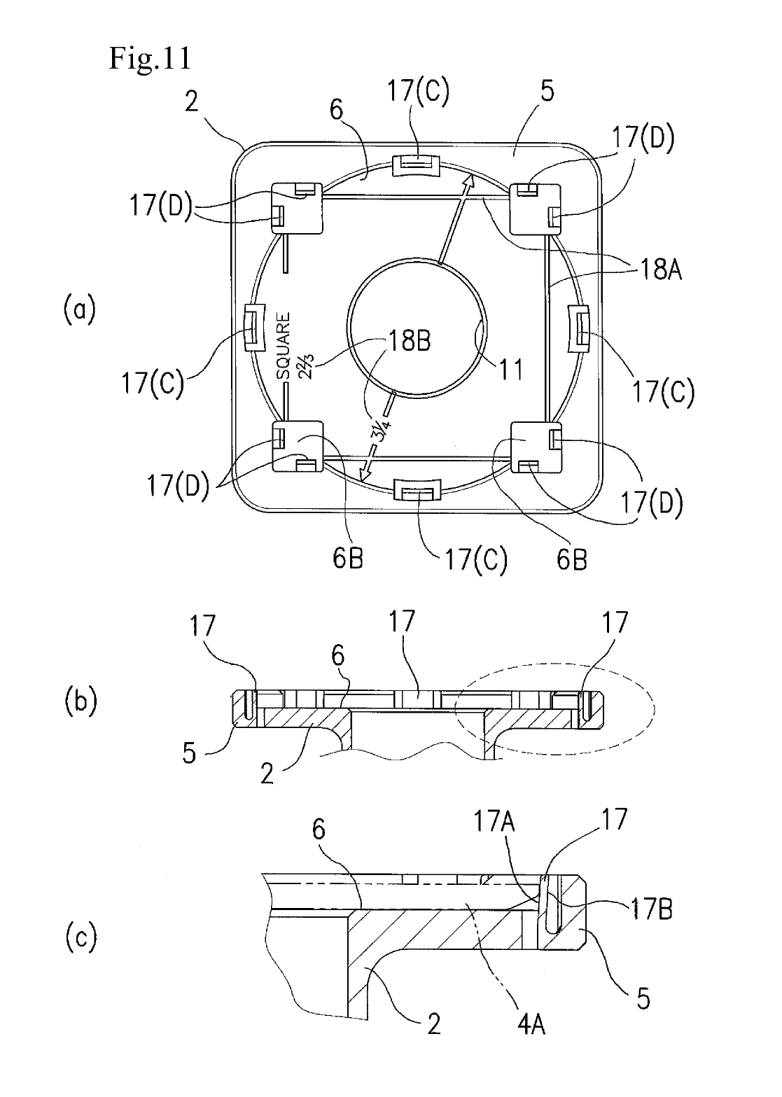

### Modification 5 of First Embodiment (FIG. 11)

The modification shown in FIG. 11 includes spring sections 17 on the periphery of the recess 6 of the support section 5 so as to bias the outer edge of the sprinkler head cover 4 toward inside of the recess 6. In order to ensure that the spring sections 17 have sufficient elasticity, the main body 2 is preferably made of a material such as a resin and a metal having elasticity.

A plurality of spring sections 17 are disposed on the periphery of the recess 6, and the distal ends of the spring sections 17 are positioned slightly close to the center of the recess 6 with respect to the edge of the cover plate 4A of the sprinkler head cover 4. When the sprinkler head cover 4 is housed in the recess 6, the spring sections 17 become slightly inclined toward outside and bias the outer edge of the cover plate 4A toward inside of the recess 6.

The spring section 17 is in a plate shape and is formed to be substantially vertical to the bottom of the recess 6, and more preferably, slightly inclined toward outside from the vertical position. Accordingly, since the side face of the cover plate 4A is biased by the spring sections 17, the cover plate 4A can be prevented from being damaged by the edge of the spring sections 17. More specifically, when the distal ends of the spring sections 17 are formed to be inclined toward inside of the recess 6, the distal ends of the spring sections 17 are disposed inside the outer peripheral edge of the cover plate 4A to prevent the sprinkler head cover 4 housed in the recess 6 from being fallen off.

In this case, when the cover plate 4A is housed in the recess 6 and is removed from the recess 6, the spring sections 17 elastically deform and the distal ends of the spring sections 17 pass over the edge of the cover plate 4A. Accordingly, among the various outer diameters of the cover plate 4A, when the outer diameter of the cover plate 4A is slightly larger than usual, the edge of the cover plate 4A may engage with the distal ends of the spring sections 17 in a stronger manner than usual, which may cause damage to the edge of the cover plate 4A.

In contrast, the spring sections 17 shown in FIG. 11 are formed to be substantially vertical to the bottom of the recess 6. When the cover plate 4A is housed in the recess 6, the spring sections 17 are elastically deformed by the cover plate 4A toward outside, and the side face of the cover plate 4A is constantly biased by the spring sections 17 toward inside of the recess 6. The spring sections 17 act on the side face of the cover plate 4A, and are elastically deformed along this side face and bias the cover plate 4A. Accordingly, the spring sections 17 are elastically deformable depending on the outer diameter of the cover plate 4A regardless of various outer diameters.

Further, since the end portion of an inner surface 17A of the spring sections 17 is rounded, the surface of the cover plate 4A is prevented from being damaged by the end portion of the spring sections 17 when the cover plate 4A is housed in the recess 6. The surrounding part of an outer surface 17B is notched so that the spring sections 17 can be easily elastically deformed toward outside.

In FIG. 11, the support section 5 accommodates two types of the cover plates 4A having circular outer shape and rectangular outer shape. The spring sections 17 include spring sections C which are used when a circular cover plate is mounted and spring sections D which are used when a rectangular cover plate is mounted. The spring sections C are positioned on the support section 5 at equal intervals without interfering corners 6B for a rectangular cover plate. The spring sections D are positioned at the corners 6B for a rectangular cover plate and is configured not to interfere with a circular cover plate when mounted on the support section 5.

The spring sections 17 contribute to prevent the cover plate 4 from being fallen off from the mounting tool 1 when the operator moves while holding the mounting tool 1 on which the cover plate 4 is placed.

Further, as shown in FIG. 11, lines 18A which indicate contours and characters 18B which indicate shapes and sizes of the cover plate 4A are provided on the support section 5. This allows the operator to intuitively recognize the cover plate 4A that the mounting tool 1 can accommodate.

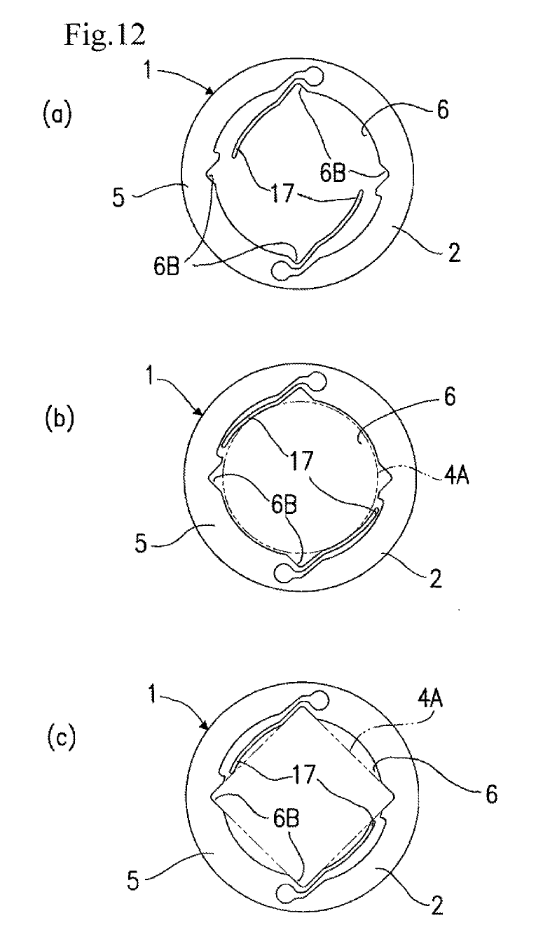

### Modification 6 of First Embodiment (FIG. 12)

In the modification shown in FIG. 12(a), the spring sections 17 extend from the periphery of the recess 6 and are curved toward inside of the recess 6. The proximal ends of the spring sections 17 are located at the corners 6B for a rectangular cover plate on the recess 6.

When the cover plate 4A is placed in the recess 6, the distal ends of the spring sections 17 are elastically deformed to the outside of the recess 6 and bias the outer edge of the cover plate 4A. FIG. 12(b) is a plan view which shows that a circular cover plate is mounted, and FIG. 12(c) is a plan view which shows that a rectangular cover plate is mounted.

As described above, the spring sections 17 contribute to prevent the sprinkler cover plate 4 from being fallen off from the mounting tool 1 since the spring section 17 bias the outer edge of the cover plate 4A toward inside of the support section when the cover plate 4 is put on the mounting tool 1.

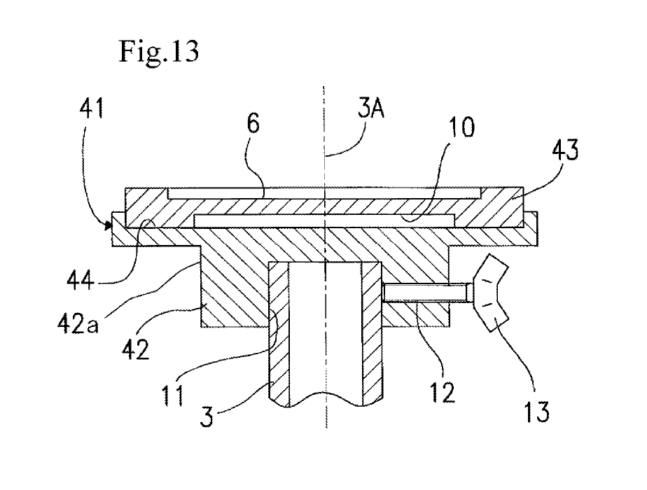

### Second Embodiment (FIG. 13)

A mounting tool 41 of a second embodiment will be described. Components having the same configuration as the first embodiment are denoted by the same reference numbers and detailed description thereof will be omitted. In the mounting tool 41 of the second embodiment, a main body 42 includes a grip rod attachment and detachment section holding member 43 and a support section holding member 42a which are capable of being separated from each other.

The mounting tool 41 of the second embodiment includes the main body 42 which is composed of the grip rod attachment and detachment section holding member 42a and a support section holding member 43, and the grip rod 3. An engagement hole 44 is formed on the top surface of the grip rod attachment and detachment section holding member 42a so that the support section holding member 43 is detachable from the engagement hole 44. The support section holding member 43 is in a disc shape, and has the recess 6 similar to that of the first embodiment formed on one face and the recess 10 similar to that of the first embodiment formed on the other face. Accordingly, the mounting tool 41 which can accommodate several types of the sprinkler head covers can be achieved by using the both faces of the support section holding member 43.

The support section holding member 43 has a circular outer shape, and the engagement hole has a circular shape having a diameter which is slightly larger than that of the outer shape of the support section holding member 43. The support section holding member 43 is configured to be detachable from the engagement hole 44. For example, the engagement hole 44 and the support section holding member 43 can be detachably attached to each other by a magnetic force, or alternatively, by threading an internal thread on the inner surface of the engagement hole 44 and forming an external thread which corresponds to the internal thread on the outer surface of the support section holding member 43.

The hole of the grip rod attachment and detachment section 11 is formed on the grip rod attachment and detachment section holding member 42a on the opposite side of the engagement hole 44 so that the grip rod 3 can be connected to the main body 42 by using the bolt 13 in the same manner as the first embodiment. Similar to the above described embodiment, the center of the engagement hole 44 is positioned on the center axis 3A of the grip rod 3 and the hole of the grip rod attachment and detachment section 11.

According to the mounting tool 41 of the second embodiment, even if the types of the sprinkler head cover 4 further increase, new support sections which correspond to those types can be used on the main body 42. Accordingly, the grip rod attachment and detachment section holding member 42a can be continuously used regardless of the increased number of types of the support sections.

Further, each of the accessories having different shapes and sizes can be put on each of the faces.

### INDUSTRIAL APPLICABILITY

The sprinkler head accessory mounting tool according to the present invention can be also applied to the ceiling plate described in Japanese Unexamined Utility Model Registration Application Publication No. 6-77758 and No. 6-41751 as well as the above described sprinkler head cover.

### REFERENCE SIGNS LIST

1, 41 sprinkler head accessory mounting tool
2, 42 main body
3 grip rod
4 sprinkler head cover
5 support section (first support section)
6, 10 recess
7 sprinkler head
9 support section (second support section)
11 grip rod attachment and detachment section
12 internal thread
13 bolt
42a grip rod attachment and detachment section holding member
43 support section holding member
44 engagement hole

1. A sprinkler head accessory mounting tool for mounting a sprinkler head accessory on a sprinkler head to cover a hole formed at an installation position of the sprinkler head on a ceiling or wall surface, comprising:
a main body and a grip rod, the main body including a plurality of support sections on which the sprinkler head accessory can be put and a grip rod attachment and detachment section.

2. The sprinkler head accessory mounting tool according to claim 1, wherein the main body is formed of a support section holding member and a grip rod attachment and detachment section holding member which are capable of being separated from each other, a support section is formed on the support section holding member, and a grip rod attachment and detachment section is formed on the grip rod attachment and detachment section holding member.

3. The sprinkler head accessory mounting tool according to claim 1, wherein a second support section is disposed on an opposite side of a first support section, the second support section being capable of supporting the sprinkler head accessory which is different in shape and size from that for the first support section.

4. The sprinkler head accessory mounting tool according claim 1, wherein a recess capable of supporting the sprinkler head accessory having a plurality of different types of contour shapes is formed on the support section.

5. The sprinkler head accessory mounting tool according to claim 1, wherein a center axis of the grip rod is aligned with a center position of the support section.

6. The sprinkler head accessory mounting tool according to claim 1, wherein a stopper capable of anchoring the grip rod to the grip rod attachment and detachment section is provided.

7. The sprinkler head accessory mounting tool according to claim 1, wherein a pipe cap which is in a cylindrical shape and is inserted into the grip rod attachment and detachment section allows the grip rod to be inserted therein, and includes a flange that is engageable with an end face of the grip rod attachment and detachment section on an outer periphery of one end of the pipe cap and a stopper that abuts an end face of the grip rod on an inner periphery of the other end of the pipe cap.

8. The sprinkler head accessory mounting tool according to claim 1, wherein a spring section is disposed on a periphery of the support section so that the spring section biases a side face of the sprinkler head accessory toward inside of the support section.

9. The sprinkler head accessory mounting tool according to claim 8, wherein the spring section is disposed inside the outer edge of the sprinkler head accessory which is put on the support section.

10. The sprinkler head accessory mounting tool according to claim 8, wherein the spring section is disposed vertical to the support section and is elastically deformable toward outside of the support section.

11. The sprinkler head accessory mounting tool according to claim 1, wherein an indication that indicates a shape or a size of the sprinkler head accessory is provided on the support section.

12. The sprinkler head accessory mounting tool according to claim 1, wherein a magnet is disposed on a portion of the support section which corresponds to a low-melting alloy disposed on the sprinkler head accessory.
